(19) United States
(12) Patent Application Publication
(10) Pub. No.: US 2025/0226126 A1
(43) Pub. Date: Jul. 10, 2025

(54) CORE COMPONENT RODLET WITH REATTACHMENT CAPABILITY

(71) Applicant: Westinghouse Electric Company LLC, Cranberry Township, PA (US)

(72) Inventors: Lisa M. Dudas, Columbia, SC (US); Robert J. Fetterman, Gibsonia, PA (US); Carter E. Lunde, Columbia, SC (US); Cory D. Hildebrand, Mount Pleasant, PA (US)

(73) Assignee: Westinghouse Electric Company LLC, Cranberry Township, PA (US)

(21) Appl. No.: 18/403,897

(22) Filed: Jan. 4, 2024

(51) Int. Cl. G21G 1/02; G21C 5/02; G21C 23/00; G21G 1/00

(52) U.S. Cl. CPC G21G 1/02; G21C 5/02; G21C 23/00; G21G 1/001

(57) ABSTRACT

A core component assembly for insertion into a fuel assembly of a nuclear reactor is disclosed. The core component assembly includes a baseplate, a connector, and a crimp nut. The baseplate includes a first side and a second side. An aperture is defined through the baseplate between the first side and the second side. The connector includes a bayonet, a threaded portion disposed beneath the bayonet, an annular shoulder disposed beneath the threaded portion, a gripping area disposed beneath the annular shoulder, and a hole disposed beneath the gripping area. The crimp nut includes a crimp sleeve and a threaded opening and is aligned with the aperture of the baseplate and welded to the first side of the baseplate. The threaded portion of the connector is threaded into the threaded opening of the crimp nut to attach the connector to the baseplate and position the bayonet within the crimp sleeve.

### FIELD

The present disclosure is generally related to nuclear power and, more particularly, is directed toward radioisotope production.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, a core component assembly for insertion into a fuel assembly of a nuclear reactor is disclosed. The core component assembly comprises a baseplate, a connector, and a crimp nut. The baseplate includes a first side and a second side. An aperture is defined through the baseplate between the first side and the second side. The connector comprises a bayonet with four sides, a threaded portion disposed beneath the bayonet, an annular shoulder disposed beneath the threaded portion, a gripping area disposed beneath the annular shoulder, and a hole disposed beneath the gripping area. The crimp nut comprises a crimp sleeve and a threaded opening. The crimp nut is aligned with the aperture of the baseplate and welded to the first side of the baseplate. The threaded portion of the connector is threaded into the threaded opening of the crimp nut to attach the connector to the baseplate and position the bayonet within the crimp sleeve.

In at least one aspect, the crimp sleeve is crimpable around the bayonet. In at least one aspect, the connector comprises an anti-galling material. In at least one aspect, the connector comprises Nitronic 60. In at least one aspect, the annular shoulder abuts the second side of the baseplate upon attachment of the connector to the baseplate. In at least one aspect, the gripping area and annular shoulder are to provide an interface for a gripper to hold the connector during rotation of the connector to prevent the connector from becoming a loose part in the reactor when the connector is detached from the baseplate. In at least one aspect, the bayonet is shaped such that a tool can provide sufficient force to overcome a crimp of the crimp sleeve to permit detachment of the connector from the baseplate. In at least one aspect, the core component assembly further comprises a rodlet. In at least one aspect, the hole is to attach the connector to the rodlet. In at least one aspect, the rodlet comprises a material to be irradiated. In at least one aspect, the material comprises cobalt 59. In at least one aspect, the material comprises one of Thorium 170 or Strontium 90.

In various aspects, a method of attaching a rodlet to a baseplate of a core component assembly is disclosed. The baseplate comprises an aperture. The method comprises welding a crimp nut to the baseplate. The crimp nut comprises a threaded opening and a crimp sleeve. The threaded opening is aligned with the aperture of the baseplate. The method further comprises attaching a connector to a top end of the rodlet. The connector comprises a threaded portion and a bayonet with four sides. The method further comprises inserting the connector into the aperture of the baseplate. The method further comprises threading the threaded portion of the connector into the threaded opening of the crimp nut to attach the connector to the baseplate and position the bayonet of the connector within the crimp sleeve of the crimp nut. The method further comprises crimping the crimp sleeve of the crimp nut.

In at least one aspect, the method further comprises irradiating the rodlet by positioning the core component assembly within a fuel assembly of a nuclear reactor during operation for a period of time. In at least one aspect, the method further comprises applying torque to the bayonet of the connector to overcome the crimp of the crimp sleeve after irradiating the rodlet. In at least one aspect, the method further comprises unthreading the threaded portion of the connector from the threaded opening of the crimp nut to detach the connector from the baseplate after applying torque to the bayonet. In at least one aspect, the method further comprises gripping the connector with a gripper to prevent the connector and the rodlet attached thereto from falling after applying torque to the bayonet. In at least one aspect, the rodlet comprises a material to be irradiated. In at least one aspect, the method further comprises harvesting the material from the irradiated rodlet after the connector is detached from the baseplate. In at least one aspect, the method further comprises re-attaching the connector and the rodlet attached thereto to the baseplate after harvesting the material. In at least one aspect, the method further comprises inserting the core component assembly into a fuel assembly of the nuclear reactor after re-attaching the connector to the baseplate. In at least one aspect, the method further comprises disposing of the fuel assembly and the core component assembly together after inserting the core component assembly into the fuel assembly of the nuclear reactor.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 is a perspective view of a nuclear reactor;

FIG. 2 is a perspective view of a core component assembly;

FIG. 3 is a perspective view of the core component assembly of FIG. 2 installed into a fuel assembly;

FIG. 4 is a cross section plan view of four fuel assemblies of the nuclear reactor of FIG. 1, illustrating a core component assembly positioned within two of the fuel assemblies;

FIG. 5 is a perspective view of a core component assembly for use in a nuclear reactor;

FIG. 6 is a perspective view of the core component assembly of FIG. 5 illustrating only a baseplate of the core component assembly with a plurality of crimp nuts and a plurality of thimble guide tube plugs attached to the baseplate;

FIG. 7 is a perspective view of one of the crimp nuts of the core component assembly of FIG. 5;

FIG. 8 is a cross section view of one of the crimp nuts of the core component assembly of FIG. 5;

FIG. 9 is a perspective view of a top connector and rodlet attached thereto of the core component assembly of FIG. 5 prior to being attached to the core component assembly;

FIG. 10 is a perspective view of one of the top connectors of the core component assembly of FIG. 5 prior to being attached to a rodlet; and

FIG. 11 is a cross section view of the core component assembly of FIG. 5 illustrating the attachment mechanism between one of the top connectors and the baseplate.

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward,” “rearward,” “left,” “right,” “upwardly,” “downwardly,” and the like are words of convenience and are not to be construed as limiting terms.

In the following description, reference characters designate like or corresponding parts throughout the several views of the drawings. Also in the following description, it is to be understood that such terms as “forward,” “rearward,” “left,” “right,” “upwardly,” “downwardly,” and the like are words of convenience and are not to be construed as limiting terms.

Before explaining various aspects of the core component assembly in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

In general, in order to irradiate targets in a pressurized water reactor (PWR) plant for use in the medical industry, isotope targets are placed into a group of core component rodlets which are then attached to a baseplate of a core component assembly that is then installed into a fuel assembly. After irradiation, the targets must be removed (e.g., harvested) from the core component rodlets to be sent to the end user. In order to facilitate harvesting the targets out of the rodlets under current core component assembly designs, a complete rodlet would have to be removed (e.g., cut) from the core component assembly and handled in the cask loading pit to extract the targets. Because the rodlet is permanently detached from the core component assembly, the harvested empty rodlet would have to be placed into a waste bin for disposal. This process would incur significant additional costs for disposal. One solution to avoid offsite disposal of the irradiated empty rodlets after harvesting is to facilitate re-attachment of the harvested rodlet to the core component assembly which can then be placed into a permanently discharged fuel assembly in the spent fuel pool, as discussed in greater detail below.

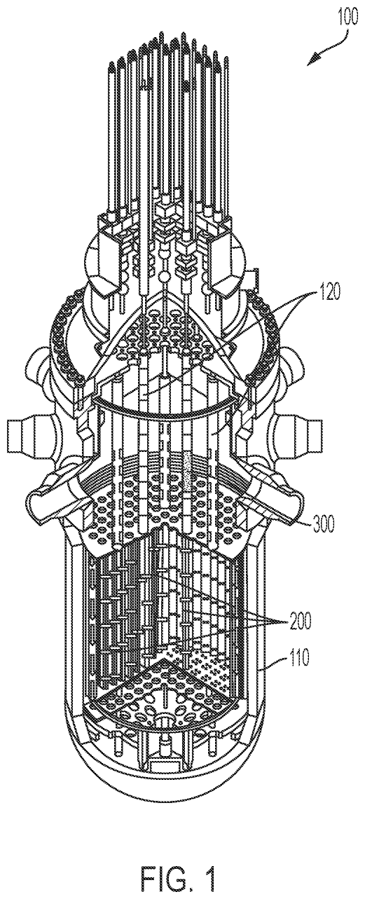

FIG. 1 illustrates a nuclear reactor 100 comprising a reactor vessel 110 including a plurality of fuel assemblies 200 positioned therein. A limited number of the fuel assemblies 200 are shown in FIG. 1 for illustrative purposes. The nuclear reactor 100 further comprises a plurality of core component guide tubes 120 above each of the fuel assemblies 200, and a plurality of core component assemblies 300 movable within the core component guide tubes 120. FIG. 1. Illustrates only one of the core component assemblies 300, however it should be understood that any number of core component assemblies 300 are movable through the core component guide tubes 120 for installation into the fuel assemblies 200. Further, the core component assemblies 300 may be of various types and designs depending on the fuel assembly type and/or region of the nuclear reactor 100 in which the core component assemblies 300 are required to be placed based on the design of the nuclear reactor 100. For example, one of the core component assemblies 300 for one of the fuel assemblies 200 may comprise a control rod core component assembly (e.g., poison control rods) and another one of the core component assemblies 300 placed in a different fuel assembly of the fuel assemblies 200 may be a moderator core component assembly such as a WABA (e.g., wet annular burnable absorber) core component assembly. In some instances, one or more of the fuel assemblies 200 may not have one of the core component assemblies 300 positioned therein based on the design of the nuclear reactor 100. Further, one or more of the core component assemblies 300 may be a COBA (e.g., cobalt burnable absorber) core component assembly, as discussed in greater detail below.

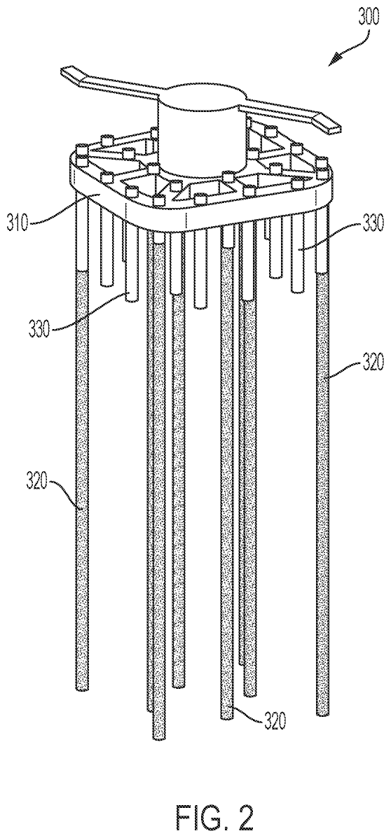

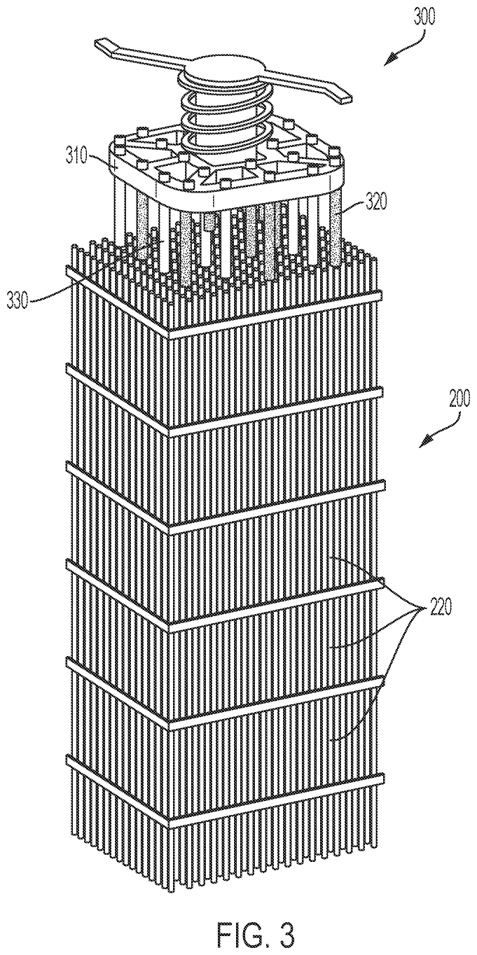

Further to the above, FIG. 2 illustrates a perspective view of one of the core component assemblies 300. In general, a typical core component assembly 300 comprises a baseplate 310 and a plurality of rodlets 320 attached to the baseplate 310. In at least one aspect, the core component assemblies 300 comprise a plurality of thimble guide tube plugs 330 that are also attached to the baseplate 310. FIG. 3 illustrates the core component assembly 300 of FIG. 2 installed into one of the fuel assemblies 200 of FIG. 1.

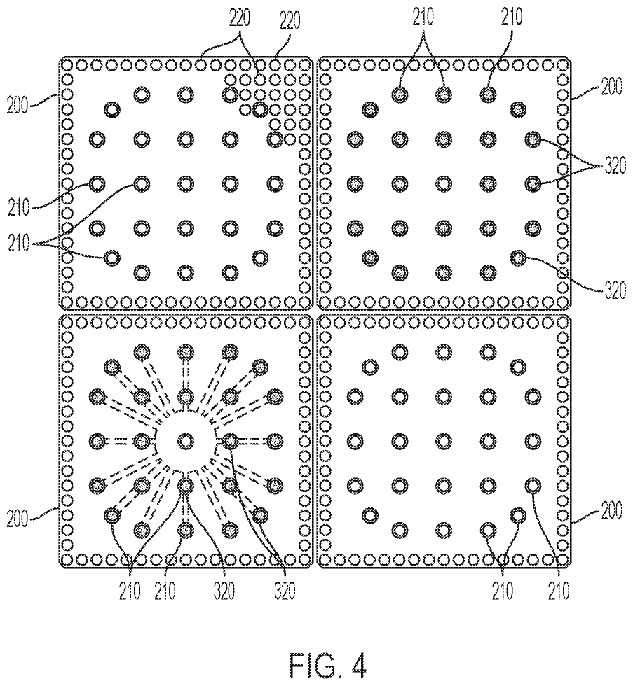

Further to the above, FIG. 4 illustrates a cross section view of a quadrant of the fuel assemblies 200 of the nuclear reactor 100 of FIG. 1. Each of the fuel assemblies 200 comprises a plurality of thimble guide tubes 210 and a plurality of fuel rods 220. When one of the core component assemblies 300 is inserted into one of the fuel assemblies 200 as shown in FIG. 3, the rodlets 320 and/or the thimble guide tube plugs 330 of the core component assembly 300 are positioned within respective thimble guide tubes 210 of the fuel assembly 200. Referring again to FIG. 4, the fuel assemblies 200 located in the upper left and bottom right do not have one of the core component assemblies 300 installed therein and the fuel assemblies 200 located in the upper right and bottom left have one of the core component assemblies 300 installed therein. Specifically, the rodlets 320 of the core component assemblies 300 are visible in the fuel assemblies 200 located in the upper right and bottom left of FIG. 4.

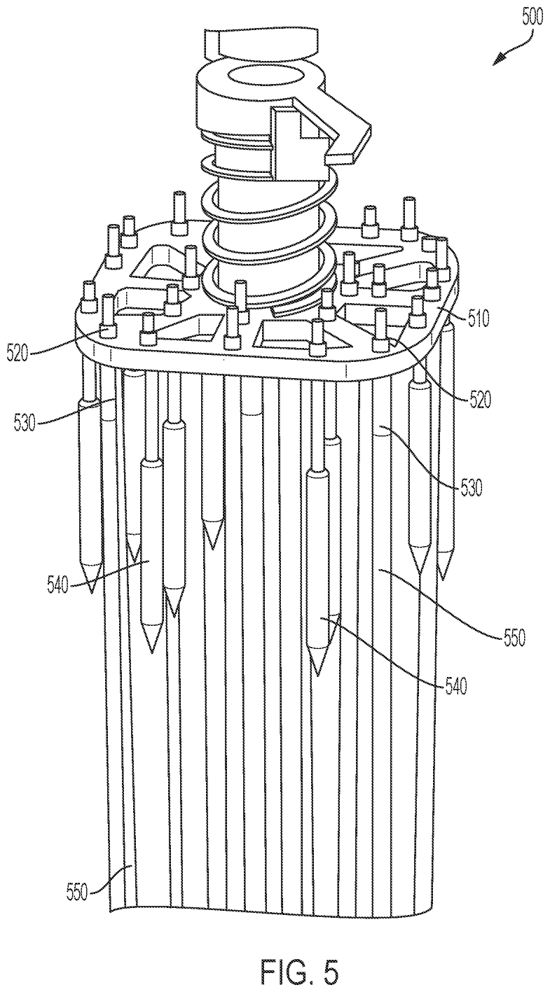

FIG. 5 illustrates a core component assembly 500 for insertion into a fuel assembly of a reactor. The core component assembly 500 is similar to the core component assemblies 300 except for the differences discussed herein. The core component assembly 500 comprises a baseplate 510, a plurality of crimp nuts 520 attached to the baseplate 510, a plurality of top connectors 530 removably attachable to the crimp nuts 520, and a plurality of rodlets 550 attached to the top connectors 530. In at least one aspect, the core component assembly 500 further comprises a plurality of thimble tube plugs 540 attached to the baseplate 510. Similar to the core component assemblies 300 discussed above, the rodlets 550 and thimble tube plugs 540 are configured to be inserted into the thimble guide tubes 210 of one of the fuel assemblies 200. In at least one aspect, the core component assembly 500 comprises twelve rodlets 550 and twelve thimble tube plugs 540 attached to the baseplate 510 prior to insertion into the fuel assemblies 200. In any event, the top connectors 530 and crimp nuts 520 facilitate initial attachment of the rodlets 550 to the baseplate 510, detachment of the rodlets 550 from the baseplate 510 after irradiating the rodlets 550, and re-attachment of the rodlets 550 to the baseplate 510 after the target material within the rodlets 550 is harvested, as discussed in greater detail below.

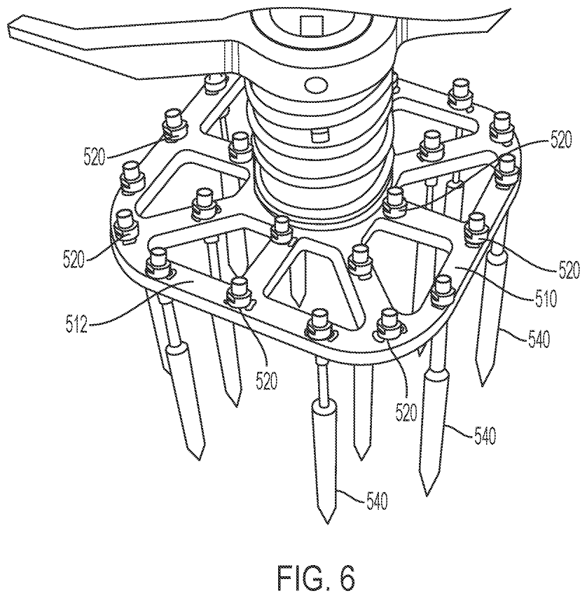

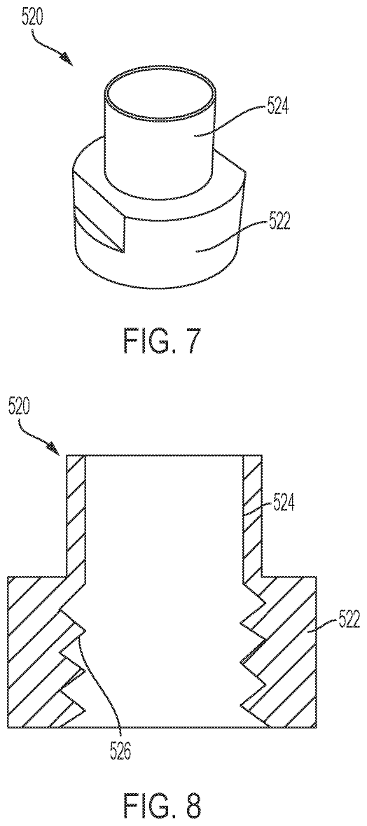

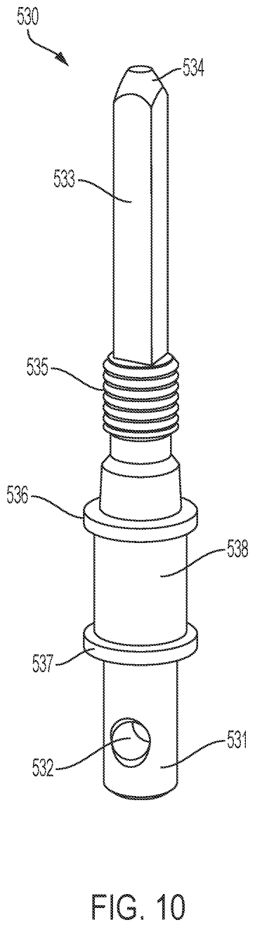

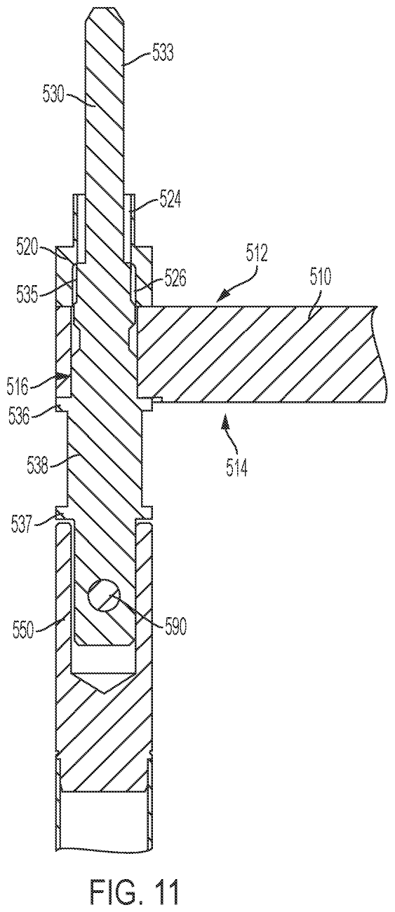

FIG. 6 illustrates the baseplate 510 of the core component assembly 500 prior to attachment of the rodlets 550. As shown in FIG. 6, the thimble tube plugs 540 have been attached to the baseplate 510. Further, the baseplate 510 comprises a first top side 512 and a second bottom side 514 (see FIG. 11) opposite the first top side 512. The baseplate 510 further comprises a plurality of apertures, or holes 516, defined through the baseplate 510 (see FIG. 10). Referring again to FIG. 6, the plurality of crimp nuts 520 are initially welded to the first top side 512 of the baseplate 510 at the locations of the holes 516. Referring primarily to FIGS. 7 and 8, each crimp nut 520 comprises a body portion 522 and a crimp sleeve 524 extending upward from the body portion 522. The body portion 522 of the crimp nut 520 comprises a threaded opening 526. The threaded opening 526 of the crimp nut 520 is aligned with the hole 516 in the baseplate 510 upon attachment of the crimp nut 520 to the baseplate 510. As such, the baseplate 510 and crimp nuts 520 shown in FIG. 6 are ready for the top connectors 530 and rodlets 550 attached thereto to be installed, as discussed in greater detail below.

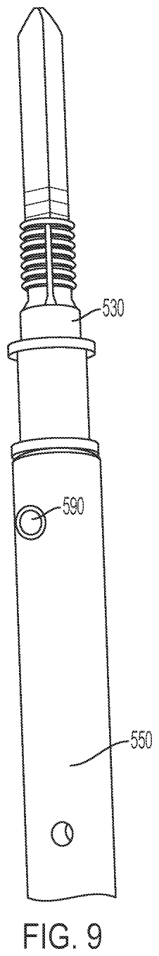

FIG. 9 illustrates one of the top connectors 530 attached to one of the rodlets 550. Specifically, a bottom boss 531 (see FIG. 10) of the top connector 530 is inserted into a top end opening of the rodlet 550. The bottom boss 531 defines a hole 532 therethrough. After the bottom boss 531 of the top connector 530 is inserted into the rodlet 550, a pin 590 is installed through an opening in the rodlet 550 and into the hole 532 of the top connector 530 to attach the top connector 530 to the rodlet 550 as shown in FIG. 9. In at least one aspect, the top connector 530 comprises a gall-resistant material. In at least one aspect, the top connector 530 comprises an anti-galling material. In at least one aspect, the top connector 530 comprises Nitronic 60. The top connector 530 is described in greater detail below.

Referring primarily to FIG. 10, the top connector 530 further comprises a bayonet portion 533, a threaded portion 535 disposed beneath the bayonet portion 533, an upper annular shoulder 536 disposed beneath the threaded portion 535, a lower annular shoulder 537 spaced apart from and disposed beneath the upper annular shoulder 536, and a gripping area 538 defined between the upper annular shoulder 536 and the lower annular shoulder 537. Further, in at least one aspect, the bayonet portion 533 comprises four substantially flat sides that terminate in a tapered portion 534 at the top end of the bayonet portion 533. The threaded portion 535 of the top connector 530 and the threaded opening 526 of the crimp nut 520 facilitate attachment of the top connector 530 and rodlet 550 to the baseplate 510, as discussed in greater detail below.

The bayonet portion 533 of the top connector 530 is inserted through the hole 516 in the baseplate 510 from the second bottom side 514 of the baseplate 510 until the threaded portion 535 of the top connector 530 engages the threaded opening 526 of the crimp nut 520. The threaded portion 535 of the top connector is threaded into the threaded opening 526 of the crimp nut until the upper annular shoulder 536 of the top connector 530 abuts the second bottom side 514 of the baseplate 510. The upper annular shoulder 536 prevents the top connector 530 from being over threaded into the crimp nut 520 and provides the user with an indication that the threaded portion 535 is properly engaged with the threaded opening 526 of the crimp nut 520. Further, when the upper annular shoulder 536 engages the second bottom side 514 of the baseplate 510, at least a portion of the bayonet portion 533 of the top connector 530 is positioned within the crimp sleeve 524. As such, a user can then crimp the crimp sleeve 524 down onto the bayonet portion 533 of the top connector 530. In other words, the crimp sleeve 524 is compressed onto the bayonet portion 533 to prevent the top connector 530 from unthreading from the baseplate 510 during operation.

Further to the above, in order to establish a robust connection between the top connector 530 and crimp nut 520, the crimp nut 520 may be oversized (e.g., comprise a larger diameter than needed) and the crimp sleeve 524 dimensions may be optimized to fit snugly within the bayonet portion 533.

After the top connectors 530 and rodlets attached thereto are attached to the baseplate 510, as discussed above, the core component assembly 500 can be inserted into one of the fuel assemblies 200 of the reactor. Each of the rodlets 550 may comprise one or more than one capsule having one or more than one isotope target material housed within the capsule. During operation of the reactor, the isotope targets will be irradiated to produce the desired isotope. In at least one instance, the target material comprises Cobalt. In at least one aspect, the target material comprises Cobalt-60. In at least one aspect, the target material comprises Cobalt-59. In at least one aspect, the target material comprises Thorium. In at least one aspect, the target material comprises Strontium. In at least one aspect, the target material comprises Thorium-170. In at least one aspect, the target material comprises Strontium-90.

Further to the above, after the rodlets 550 of the core component assembly 500 have experienced one or more than one irradiation cycle, the core component assembly 500 can be removed from one of the fuel assemblies 200 and the top connectors 530 can be detached from the baseplate 510 to harvest the isotope targets within the rodlets 550. Specifically, to detach the top connector 530 and rodlet 550 from the baseplate 510, sufficient torque is applied to the top connector 530 to overcome the crimp of the crimp sleeve 524 to permit the threaded portion 535 of the top connector 530 to be unthreaded from the crimp nut 520 of the baseplate 510. In at least one aspect, torque is applied to the bayonet portion 533 of the top connector 530 to overcome the crimp of the crimp sleeve 524. In at least one aspect, the substantially flat sides of the bayonet portion 533 are gripped with a specially designed tool to break the crimp of the crimp sleeve 524 and/or to unthread the top connector 530 from the crimp nut 520. In any event, the top connector 530 is unthreaded such that the top connector 530 is detached from the baseplate 510 on the same side that it was initially installed (e.g., on the second bottom side 514 of the baseplate 510).

Further to the above, in at least one aspect, the upper annular shoulder 536 and gripping area 538 are held with a gripping tool during attachment and/or detachment of the top connector 530 to/from the baseplate 510 so that the top connector 530 and rodlet 550 remain secure during attachment and detachment operations. Specifically, the upper and lower annular shoulders 536,537 and gripping area 538 provide a place for a gripper to interface with the top connector 530 so that it remains secure at all times, e.g., even while the top connector 530 is being rotated (threaded or unthreaded from above). In at least one aspect, this prevents the top connector 530 and the rodlet 550 attached thereto from falling during attachment and detachment.

Further to the above, after the top connector 530 and rodlet 550 are detached from the baseplate 510, the rodlet 550 can be cut open to retrieve the capsules comprising the isotope targets without detaching the rodlet 550 from the top connector 530. In at least one aspect, the upper and lower annular shoulders 536, 537 and gripping area 538 of the top connector 530 provide a secure location to hold the rodlet 550 during the target removal operation (e.g., harvesting). After the isotope targets are removed from the rodlet 550, the top connector 530 is reinserted from the bottom of the baseplate (e.g., on the second bottom side 514) and threaded into the crimp nut 520 of the baseplate 510 to re-attach the top connector 530 and rodlet 550 attached thereto to the baseplate 510. After all of the top connectors 530 and the harvested rodlets 550 are re-attached to the baseplate 510 of the core component assembly 500, the core component assembly 500 can be inserted into a spent fuel assembly. As such, each individual rodlet of the rodlets 550 does not take up space in a waste container, but rather the entire spent core component assembly 500 can be placed into a spent fuel assembly for disposal.

Various aspects of the present disclosure include, but are not limited to, the aspects listed in the following numbered clauses.

Clause 1—A core component assembly for insertion into a fuel assembly of a nuclear reactor, the core component assembly comprises a baseplate, a connector, and a crimp nut. The baseplate includes a first side and a second side. An aperture is defined through the baseplate between the first side and the second side. The connector comprises a bayonet with four sides, a threaded portion disposed beneath the bayonet, an annular shoulder disposed beneath the threaded portion, a gripping area disposed beneath the annular shoulder, and a hole disposed beneath the gripping area. The crimp nut comprises a crimp sleeve and a threaded opening. The crimp nut is aligned with the aperture of the baseplate and welded to the first side of the baseplate. The threaded portion of the connector is threaded into the threaded opening of the crimp nut to attach the connector to the baseplate and position the bayonet within the crimp sleeve.

Clause 2—The core component assembly of clause 1, wherein the crimp sleeve is crimpable around the bayonet.

Clause 3—The core component assembly of clause 1 or 2, wherein the connector comprises an anti-galling material.

Clause 4—The core component assembly of clauses 1, 2, or 3, wherein the connector comprises Nitronic 60.

Clause 5—The core component assembly of clauses 1, 2, 3, or 4, wherein the annular shoulder abuts the second side of the baseplate upon attachment of the connector to the baseplate.

Clause 6—The core component assembly of clauses 1, 2, 3, 4, or 5, wherein the gripping area and annular shoulder are to provide an interface for a gripper to hold the connector during rotation of the connector to prevent the connector from becoming a loose part in the reactor when the connector is detached from the baseplate.

Clause 7—The core component assembly of clauses 1, 2, 3, 4, 5, or 6, the bayonet is shaped such that a tool can provide sufficient force to overcome a crimp of the crimp sleeve to permit detachment of the connector from the baseplate.

Clause 8—The core component assembly of clauses 1, 2, 3, 4, 5, 6, or 7, further comprising a rodlet, wherein the hole is to attach the connector to the rodlet.

Clause 9—The core component assembly of clause 8, wherein the rodlet comprises a material to be irradiated.

Clause 10—The core component assembly of clause 9, wherein the material comprises cobalt 59.

Clause 11—The core component assembly of clause 9, wherein the material comprises one of Thorium 170 or Strontium 90.

Clause 12—A method of attaching a rodlet to a baseplate of a core component assembly, the baseplate comprises an aperture. The method comprises welding a crimp nut to the baseplate. The crimp nut comprises a threaded opening and a crimp sleeve. The threaded opening is aligned with the aperture of the baseplate. The method further comprises attaching a connector to a top end of the rodlet. The connector comprises a threaded portion and a bayonet with four sides. The method further comprises inserting the connector into the aperture of the baseplate. The method further comprises threading the threaded portion of the connector into the threaded opening of the crimp nut to attach the connector to the baseplate and position the bayonet of the connector within the crimp sleeve of the crimp nut. The method further comprises crimping the crimp sleeve of the crimp nut.

Clause 13—The method of clause 12, further comprising irradiating the rodlet by positioning the core component assembly within a fuel assembly of a nuclear reactor during operation for a period of time.

Clause 14—The method of clause 13, further comprising applying torque to the bayonet of the connector to overcome the crimp of the crimp sleeve after irradiating the rodlet.

Clause 15—The method of clause 14, further comprising unthreading the threaded portion of the connector from the threaded opening of the crimp nut to detach the connector from the baseplate after applying torque to the bayonet.

Clause 16—The method of clause 14 or 15, further comprising gripping the connector with a gripper to prevent the connector and rodlet attached thereto from falling after applying torque to the bayonet

Clause 17—The method of clauses 15 or 16, wherein the rodlet comprises a material to be irradiated, wherein the method further comprises harvesting the material from the irradiated rodlet after the connector is detached from the baseplate

Clause 18—The method of clause 17, further comprising the re-attaching the connector and rodlet attached thereto to the baseplate after harvesting the material.

Clause 19—The method of clause 18, further comprising inserting the core component assembly into a fuel assembly of the nuclear reactor after re-attaching the connector to the baseplate.

Clause 20—The method of clause 19, further comprising disposing of the fuel assembly and the core component assembly together after inserting the core component assembly into the fuel assembly of the nuclear reactor.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention. Accordingly, it will be recognized by persons having ordinary skill in the art that various substitutions, modifications or combinations of any of the exemplary aspects may be made without departing from the scope of the invention. In addition, persons skilled in the art will recognize, or be able to ascertain using no more than routine experimentation, many equivalents to the various aspects of the invention described herein upon review of this specification. Thus, the invention is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

What is claimed is:

1. A core component assembly for insertion into a fuel assembly of a nuclear reactor, wherein the core component assembly comprises:
a baseplate with a first side and a second side, wherein an aperture is defined through the baseplate between the first side and the second side;
a connector, comprising:
a bayonet with four sides;
a threaded portion disposed beneath the bayonet;
an annular shoulder disposed beneath the threaded portion;
a gripping area disposed beneath the annular shoulder; and
a hole disposed beneath the gripping area; and
a crimp nut comprising a crimp sleeve and a threaded opening, wherein the crimp nut is aligned with the aperture of the baseplate and welded to the first side of the baseplate, and wherein the threaded portion of the connector is threaded into the threaded opening of the crimp nut to attach the connector to the baseplate and position the bayonet within the crimp sleeve.

2. The core component assembly of claim 1, wherein the crimp sleeve is crimpable around the bayonet.

3. The core component assembly of claim 1, wherein the connector comprises an anti-galling material.

4. The core component assembly of claim 1, wherein the connector comprises Nitronic 60.

5. The core component assembly of claim 1, wherein the annular shoulder abuts the second side of the baseplate upon attachment of the connector to the baseplate.

6. The core component assembly of claim 1, wherein the gripping area and annular shoulder are to provide an interface for a gripper to hold the connector during rotation of the connector to prevent the connector from becoming a loose part in the reactor when the connector is detached from the baseplate.

7. The core component assembly of claim 1, the bayonet is shaped such that a tool can provide sufficient force to overcome a crimp of the crimp sleeve to permit detachment of the connector from the baseplate.

8. The core component assembly of claim 1, further comprising a rodlet, wherein the hole is to attach the connector to the rodlet.

9. The core component assembly of claim 8, wherein the rodlet comprises a material to be irradiated.

10. The core component assembly of claim 9, wherein the material comprises cobalt 59.

11. The core component assembly of claim 9, wherein the material comprises one of Thorium 170 or Strontium 90.

12. A method of attaching a rodlet to a baseplate of a core component assembly, wherein the baseplate comprises an aperture, wherein the method comprises:
welding a crimp nut to the baseplate, wherein the crimp nut comprises a threaded opening and a crimp sleeve, wherein the threaded opening is aligned with the aperture of the baseplate;
attaching a connector to a top end of the rodlet, wherein the connector comprises a threaded portion and a bayonet with four sides;
inserting the connector into the aperture of the baseplate;
threading the threaded portion of the connector into the threaded opening of the crimp nut to attach the connector to the baseplate and position the bayonet of the connector within the crimp sleeve of the crimp nut; and
crimping the crimp sleeve of the crimp nut.

13. The method of claim 12, further comprising irradiating the rodlet by positioning the core component assembly within a fuel assembly of a nuclear reactor during operation for a period of time.

14. The method of claim 13, further comprising applying torque to the bayonet of the connector to overcome a crimp of the crimp sleeve after irradiating the rodlet.

15. The method of claim 14, further comprising unthreading the threaded portion of the connector from the threaded opening of the crimp nut to detach the connector from the baseplate after applying torque to the bayonet.

16. The method of claim 14, further comprising gripping the connector with a gripper to prevent the connector and rodlet attached thereto from falling after applying torque to the bayonet

17. The method of claim 15, wherein the rodlet comprises a material to be irradiated, wherein the method further comprises harvesting the material from the irradiated rodlet after connector is detached from the baseplate

18. The method of claim 17, further comprising re-attaching the connector and rodlet attached thereto to the baseplate after harvesting the material.

19. The method of claim 18, further comprising inserting the core component assembly into a fuel assembly of the nuclear reactor after re-attaching the connector to the baseplate.

20. The method of claim 19, further comprising disposing of the fuel assembly and the core component assembly together after inserting the core component assembly into the fuel assembly of the nuclear reactor.
